(19) United States
(12) Patent Application Publication
(10) Pub. No.: US 2024/0214215 A1
(43) Pub. Date: Jun. 27, 2024

(54) SYSTEMS AND METHODS FOR FACILITATING INITIAL DEPLOYMENTS OF CRYPTOGRAPHIC ASSETS ACROSS COMPUTER NETWORKS IN A CRYPTOGRAPHICALLY SECURE MANNER

(71) Applicant: Coinbase, Inc., Oakland, CA (US)

(72) Inventors: Sean GENG, Oakland, CA (US); Theo SZYMKOWIAK, Oakland, CA (US); Ankit CHIPLUNKAR, Oakland, CA (US)

(73) Assignee: Coinbase, Inc., Oakland, CA (US)

(21) Appl. No.: 18/145,642

(22) Filed: Dec. 22, 2022

(51) Int. Cl. H04L 9/32

(52) U.S. Cl. CPC H04L 9/3247; H04L 9/3236; H04L 9/3297

(57) ABSTRACT

Systems and methods are described herein for novel uses and/or improvements to blockchains and blockchain technology. As one example, methods and systems are described herein for facilitating initial deployments of cryptographic assets across computer networks in a cryptographically secure manner while mitigating interactions with computer programs that simulate human activity.

### BACKGROUND

In recent years, the use of blockchains and blockchain technology has exponentially increased. Blockchains comprise a list of records, called “blocks,” that are “chained” together using cryptography. Each block may comprise data that is computed using a one-way function (e.g., a function that is practically impossible to invert or reverse-compute) of a previous block, a timestamp (e.g., indicating a creation and/or modification time), and additional data (e.g., transactional or operational data related to blockchain operations).

While publicity for blockchains and blockchain technology has been concentrated on its use for cryptocurrencies and smart contracts, blockchains and blockchain technology may be applicable to numerous technological avenues. A common theme of the technological avenues is the manner in which blockchains and blockchain technology are decentralized such that facilitation, management, and/or verification of blockchain-based operations is governed or administered not by any one authority but instead by a community of users. The blockchain may therefore remain distributed (e.g., on a network of computers that communicate and coordinate their actions by passing messages to one another), and in many cases public, through a digital ledger, which records the series of blocks forming the chain. Notably, because each block depends on a preceding block, edits to existing blocks in the chain may not be made without affecting subsequent blocks.

Furthermore, updates to the blockchain (e.g., the addition of new blocks) may include incentivization systems that reward community members for the generation of the updates while also ensuring a consensus by the community. By doing so, the proliferation of the blockchain may proceed indefinitely.

### SUMMARY

Systems and methods are described herein for novel uses and/or improvements to blockchains and blockchain technology. As one example, methods and systems are described herein for facilitating initial deployments of cryptographic assets across a computer network in a cryptographically secure manner while mitigating interactions with computer programs that simulate human activity. For example, initial deployments of cryptographic assets, particularly those that occur at a time set before (also referred to as a “drop”) are a popular mechanism for generating interest in new cryptographic assets. However, these drops are rife with technical issues stemming from the sudden explosion in blockchain activity that is a characteristic (and an intended result) of the cryptographic asset provider.

For example, conventional systems are prone to being overrun by automated programs (e.g., “bots”). For example, the use of bots may generate an overwhelming amount of blockchain operations to a single block in a blockchain network. Not only does this increase congestion on the network, but it can also lead to gas wars between the bots as well as actual users. During times of high network traffic, such as during a gas war, validators include only blockchain operations having the highest gas limits (e.g., an upper limit to be used for the blockchain operation). The blockchain operations that do not have the highest gas limits are not able to be included on a block. For each such failed blockchain operation, the bot and/or user is able to receive any cryptographic assets associated with the blockchain operation back, such as any cryptocurrency intended to be transferred in a transaction. However, the bot and/or user is not able to receive gas fees back. This leads to not only network congestion and user frustration, but also loss of monetary value in the form of gas fees.

To overcome these technical deficiencies in conventional systems, systems and methods disclosed herein utilize a self-executing program that authorizes the sale of a previously-minted unique digital asset. For example, the self-executing program authorizes a sale of a previously-minted unique digital asset. This allows the system to maintain the prestige of being an initial release or delivery date of the unique digital assets but does not require the self-executing program to execute the sale to mint the unique digital asset. For example, by requiring the signature used to buy the unique digital asset to be received from the platform service, the system allows the platform service to provide an initial gatekeeper role prior to the drop of the unique digital asset (and thus prevent gas wars). As the gatekeeper, the platform service may perform one or more validations of the user to ensure that specific conditions about the user are met (e.g., ensuring that the user is not a bot account). Upon validation, the platform service may issue a signature that may be used to obtain the unique digital asset at the drop. The signature may be specific to the unique digital asset and may have additional limitations (e.g., time periods for use, a predetermined cost, etc.). These additional limitations also ensure that only a specific user, and at a specific time, may obtain the unique digital asset. This allows the unique digital asset to be minted ahead of time, while still maintaining the prestige of being an initial release of the unique digital asset. Accordingly, the systems and methods provided allow the platform to pre-validate potential purchases which will limit bot-operations and minimize gas fees for users associated with failed transfers.

In some aspects, methods and systems for facilitating initial deployments of cryptographic assets across a computer network in a cryptographically secure manner while mitigating interactions with computer programs that simulate human activity are described. For example, the system may receive a first request, from a first user account corresponding to a first address of a cryptography-based, storage application, to obtain a first signature for a first self-executing program, wherein the first self-executing program is configured to authorize a transfer of a first previously-minted unique digital asset of a first unique digital asset collection. The system may, in response to the first request, determine a required account characteristic based on the first request. The system may retrieve a first account characteristic for the first user account. The system may validate the first user account based on comparing the required account characteristic to the first account characteristic. The system may then issue the first signature to the first address of the cryptography-based, storage application.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for facilitating initial deployments of cryptographic assets across a computer network in a cryptographically secure manner while mitigating interactions with computer programs that simulate human activity, in accordance with one or more embodiments.

FIG. 2 shows an illustrative diagram for conducting blockchain operations, in accordance with one or more embodiments.

FIG. 3 shows an illustrative diagram for a decentralized application, in accordance with one or more embodiments.

FIG. 4 shows an illustrative diagram for conducting operations in a decentralized application using blockchain operations, in accordance with one or more embodiments.

FIG. 5 shows an illustrative diagram for a blockchain indexer, in accordance with one or more embodiments.

FIG. 6 shows a flowchart of the steps involved in facilitating initial deployments of cryptographic assets across a computer network in a cryptographically secure manner while mitigating interactions with computer programs that simulate human activity, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

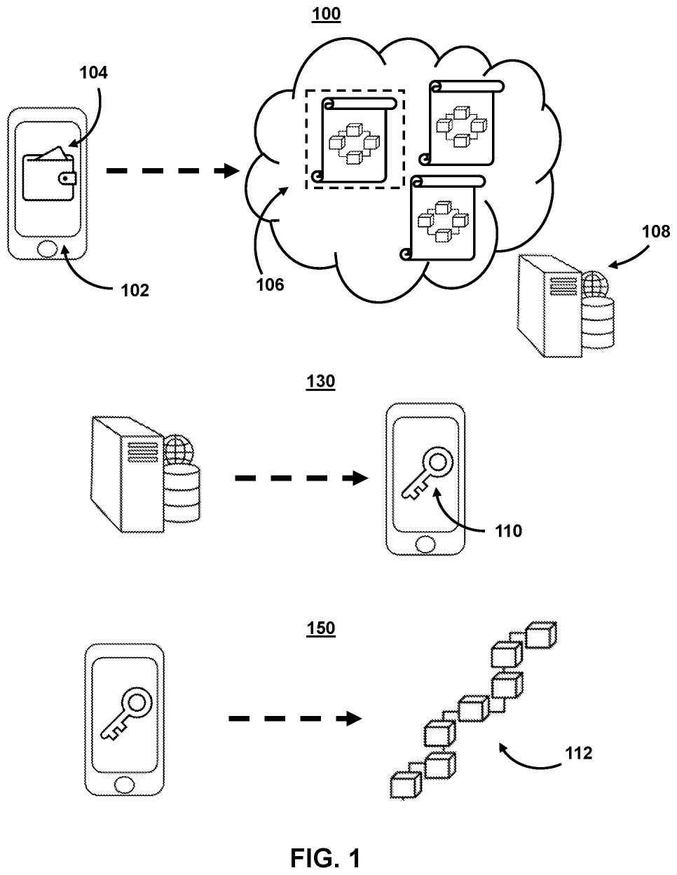

FIG. 1 shows an illustrative diagram for facilitating initial deployments of cryptographic assets across a computer network in a cryptographically secure manner while mitigating interactions with computer programs that simulate human activity, in accordance with one or more embodiments. For example, FIG. 1 illustrates the utilization of a self-executing program that authorizes the sale of a previously-minted unique digital asset. For example, by utilizing a self-executing program that authorizes a sale of a previously-minted unique digital asset, the system may maintain the prestige of being an initial release or delivery date of the unique digital assets, but does not require the self-executing program to execute the sale to mint the unique digital asset. As such, the system may pre-validate potential buyers, ensuring that the buyer is not a bot, and minimize gas fees for users for failed transfers.

A bot, short for robot and also called an Internet bot, may be a computer program that operates as an agent for a user or other program or to simulate a human activity. Bots are normally used to automate certain tasks, meaning they can run without specific instructions from humans. Bots can exacerbate gas wars. A gas war occurs when the demand to mint a new unique digital asset collection is greater than the blockchain network can process. Gas wars can clog the blockchain network for hours, and users still have to pay the gas fee for the failed transfer.

FIG. 1 shows processes 100, 130, and 150. Process 100 includes user device 102, cryptography-based storage application 104, unique digital asset 106, and server 108. Process 130 includes server 108 and signature 110. Process 150 includes signature 110 and blockchain network 112.

The system may use a unique digital asset. As referred to herein, “unique digital asset” may refer to a non-fungible token. In some embodiments, a unique digital asset may include a record on a blockchain which is associated with a particular digital or physical asset. In some embodiments, a unique digital asset may include a cryptographic asset on a blockchain with a unique identification code and metadata that distinguishes it from other assets. In some embodiments, one or more unique digital assets may be released as a collection on a platform as a drop.

The system may use cryptography-based digital repositories or a cryptography-based storage application. As referred to herein, “cryptography-based digital repositories” and/or “cryptography-based storage application” may refer to a digital wallet. In some embodiments, the digital wallet may include a software-based system that securely stores users, confidential information, personal information, payment information, and/or passwords, for numerous payment methods and websites in an encrypted format. By using a “cryptography-based storage application,” users may complete communications, purchases, and/or other blockchain operations easily and securely without risking the information becoming public or subject to a cyberattack.

In process 100, the system (e.g., an application programming interface (API)) may receive a first request from a first user account corresponding to a first address of a cryptography-based storage application 104 to obtain a first signature (e.g., signature 110) for a first self-executing program, wherein the first self-executing program is configured to authorize a transfer of a first previously-minted unique digital asset (e.g., unique digital asset 106) of a first unique digital asset collection.

In some embodiments, the system (e.g., an API) may generate for display, on a user interface, a listing for the first unique digital asset collection. The system (e.g., an API) may then receive a user selection selecting a visual element such as an icon corresponding for a first previously-minted unique digital asset (e.g., unique digital asset 106) of the first unique digital asset collection.

The system may use a user account (e.g., represented by an email address) that corresponds to an account for the blockchain platform service. In some embodiments, the user account on the platform service is linked or associated with one or more blockchain addresses of a non-custodial cryptography-based storage application. By having a user account that corresponds to the platform service that is separate and distinct from an address of a non-custodial cryptography-based storage application, the system may provide additional features that would not be possible with conventional blockchain operations. For example, the system may augment and/or modify blockchain operations prior to completion in order to prevent fraud, verify user intent, and/or otherwise increase security. Additionally, or alternatively, by having a user account that corresponds to the platform service that is separate and distinct from a non-custodial cryptography-based storage application, the system may provide a single user the ability to access multiple addresses of a non-custodial cryptography-based storage application using a single account for the platform service. In some embodiments, the user account is on the platform service is linked or associated with one or more blockchain addresses of a custodial wallet of the platform service.

The system may use a self-executing program. As referred herein, the “self-executing program” may include a drop exchange smart contract. In some embodiments, a self-executing program may include a smart contract that allows a creator to set limits on who can buy a given unique digital asset. In some embodiments, a self-executing program may include a smart contract that allows a creator to set limits on how many unique digital assets a given user may buy. The smart contract may perform this using specialized signatures. For example, a clearinghouse, central authority, and/or other middleman may hold a private key that can authorize sales on-chain. When a user chooses to claim a unique digital asset, the front end of the central authority would request a signature from the back end. Then, the user would send a transaction to the smart contract with the received signature to buy the unique digital asset.

The system may, in response to the first request, determine a required account characteristic based on the first request. The system may monitor content generated by, accessed within, and/or otherwise consumed by a user or user account to generate user account data. As referred to herein, “an account profile” and/or “account profile data” may comprise data actively and/or passively collected about a user, user device, and/or user account. For example, the account profile data may comprise content generated by the user and an account characteristic for the user account.

Account profile data may also include an account characteristic. As referred to herein, “an account characteristic” may include information about a user and/or user account including previous blockchain operations, potential future blockchain operations, user and/or account settings, user and/or account preferences, and/or other information about the user, user device, and/or user account.

In process 130, the system (e.g., an API) may retrieve a first account characteristic for the first user account. For example, the API calls server 108 to request user device 102 for an account characteristic. In some embodiments, the API used in process 130 may be different than the API used in process 100. The system may validate the first user account based on comparing the required account characteristic to the first account characteristic. For example, the API calls server 108 to validate the account characteristic.

In some examples, retrieving the first account characteristic for the first user account may include retrieving a current amount in the first address of the cryptography-based storage application for the first user account. In this case, validating the first user account based on the first account characteristic may include determining whether the current amount equals or exceeds a required value for the first previously-minted unique digital asset.

In some examples, the required account characteristic comprises a social media characteristic of the first user account and retrieving the first account characteristic for the first user account may include retrieving the social media characteristic for the first user account. In this case, validating the first user account includes verifying that a social media account linked to the user account follows a particular social media account.

Additionally or alternatively, the required account characteristic may include a know-your-customer characteristic of the first user account. In this case, retrieving the first account characteristic for the first user account may include retrieving the know-your-customer characteristic for the first user account. Validating the first user account may include verifying that the first user account has completed a know-your-customer process.

As another example, the required account characteristic may include ownership of an additional unique digital asset by the first address, and retrieving the first account characteristic for the first user account may include determining whether the first address currently owns the additional unique digital asset based on a current state of a blockchain.

In process 150, the system (e.g., an API) may issue the first signature to the first address of the cryptography-based storage application. For example, the API issues a signature authorizing the sale of the unique digital asset. The system may issue the signature to the address of a cryptography-based storage application associated with user device 102. The system may access blockchain network 112 to transfer the unique digital asset. In some embodiments, the API used in process 150 may be different than the API used in process 100 and the API used in process 130. In some embodiments, the system may issue the first signature to the first address of the cryptography-based, storage application.

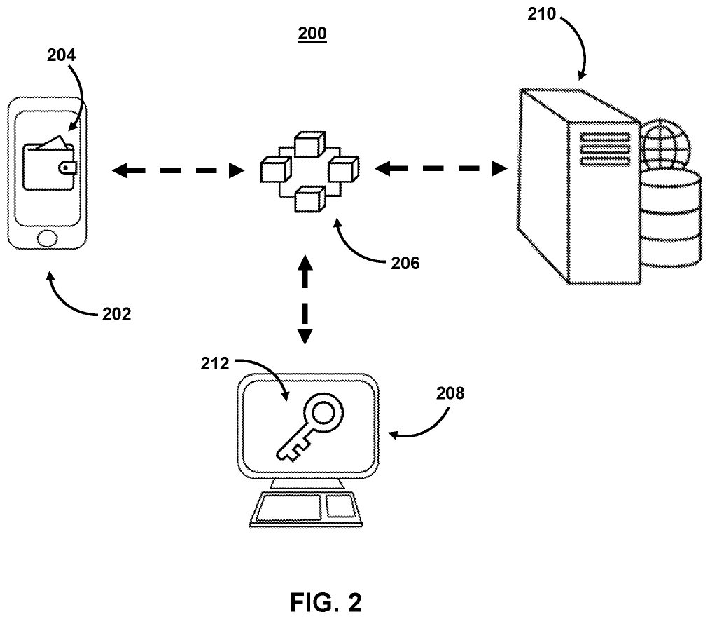

FIG. 2 shows an illustrative diagram for conducting blockchain operations, in accordance with one or more embodiments. For example, the diagram presents various components that may be used to facilitate initial deployments of cryptographic assets across computer networks in a cryptographically secure manner while mitigating interactions with computer programs that simulate human activity in some embodiments.

FIG. 2 includes user device 202. User device 202 may include a user interface. As referred to herein, a “user interface” may comprise a mechanism for human-computer interaction and communication in a device and may include display screens, keyboards, a mouse, and the appearance of a desktop. For example, a user interface may comprise a way a user interacts with an application or website in order to facilitate initial deployments of cryptographic assets across computer networks in a cryptographically secure manner while mitigating interactions with computer programs that simulate human activity, and the user interface may display content related to facilitating initial deployments of cryptographic assets across computer networks in a cryptographically secure manner while mitigating interactions with computer programs that simulate human activity. As referred to herein, “content” should be understood to mean an electronically consumable user asset, representations of goods or services (including non-fungible tokens), Internet content (e.g., streaming content, downloadable content, webcasts, etc.), video data, audio data, image data, and/or textual data, etc.

As shown in FIG. 2, system 200 may include multiple user devices (e.g., user device 202, user device 208, and/or user device 210). For example, system 200 may comprise a distributed state machine, in which each of the components in FIG. 2 acts as a client of system 200. For example, system 200 (as well as other systems described herein) may comprise a large data structure that holds not only all accounts and balances but also a state machine, which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system.

It should be noted that, while shown as a smartphone, a personal computer, and a server in FIG. 2, the user devices may be any type of computing device, including, but not limited to, a laptop computer, a tablet computer, a hand-held computer, and/or other computing equipment (e.g., a server), including “smart,” wireless, wearable, and/or mobile devices. It should be noted that embodiments describing system 200 performing a blockchain operation may equally be applied to, and correspond to, an individual user device (e.g., user device 202, user device 208, and/or user device 210) performing the blockchain operation. That is, system 200 may correspond to the user devices (e.g., user device 202, user device 208, and/or user device 210) collectively or individually.

Each of the user devices may be used by the system to conduct blockchain operations and/or contribute to facilitating initial deployments of cryptographic assets across computer networks in a cryptographically secure manner while mitigating interactions with computer programs that simulate human activity. As referred to herein, “blockchain operations” may comprise any operations including and/or related to blockchains and blockchain technology. For example, blockchain operations may include conducting transactions, querying a distributed ledger, generating additional blocks for a blockchain, transmitting communications-related non-fungible tokens, performing encryption/decryption, exchanging public/private keys, and/or other operations related to blockchains and blockchain technology. In some embodiments, a blockchain operation may comprise the creation, modification, detection, and/or execution of a smart contract or program stored on a blockchain. For example, a smart contract may comprise a program stored on a blockchain that is executed (e.g., automatically, without any intermediary's involvement or time loss) when one or more predetermined conditions are met. In some embodiments, a blockchain operation may comprise the creation, modification, exchange, and/or review of a token (e.g., a digital blockchain-specific asset), including a non-fungible token. A non-fungible token may comprise a token that is associated with a good, a service, a smart contract, and/or other content that may be verified by, and stored using, blockchain technology.

In some embodiments, blockchain operations may also comprise actions related to mechanisms that facilitate other blockchain operations (e.g., actions related to metering activities for blockchain operations on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every blockchain operation (e.g., computation, data access, transaction, etc.). Each blockchain operation has a predetermined cost in units of gas (e.g., as determined based on a predefined set of rules for the system). When a blockchain operation triggers the execution of a smart contract, the blockchain operation may include an amount of gas that sets the upper limit of what can be consumed in running the smart contract. The system may terminate execution of the smart contract if the amount of gas consumed by computation exceeds the gas available in the blockchain operation. For example, in Ethereum, gas comprises a mechanism for allowing Turing-complete computation while limiting the resources that any smart contract and/or blockchain operation may consume.

In some embodiments, gas may be obtained as part of a blockchain operation (e.g., a purchase) using a network-specific cryptocurrency (e.g., ether in the case of Ethereum). The system may require gas (or the amount of the network-specific cryptocurrency corresponding to the required amount of gas) to be transmitted with the blockchain operation as an earmark to the blockchain operation. In some embodiments, gas that is earmarked for a blockchain operation may be refunded back to the originator of the blockchain operation if, after the computation is executed, an amount remains unused.

As shown in FIG. 2, one or more user devices may include a cryptography-based storage application (e.g., digital wallet 204) used to perform blockchain operations. The cryptography-based storage application may be used to perform a plurality of blockchain operations across a computer network. The cryptography-based storage application may, in some embodiments, correspond to a digital wallet. For example, the digital wallet may comprise a repository that allows users to store, manage, and trade their cryptocurrencies and assets, interact with blockchains, and/or conduct blockchain operations using one or more applications. The digital wallet may be specific to a given blockchain protocol or may provide access to multiple blockchain protocols. In some embodiments, the system may use various types of wallets such as hot wallets and cold wallets. Hot wallets are connected to the Internet while cold wallets are not. Digital wallet holders may hold both a hot wallet and a cold wallet. Hot wallets are most often used to perform blockchain operations, while a cold wallet is generally used for managing a user account and may have no connection to the Internet.

In some embodiments, the cryptography-based storage application may correspond to a key-based wallet or a smart contract wallet. For example, a key-based wallet may feature public or private keys and allow a user to either have control of the account or receive transactions in the account. A smart contract wallet may comprise blockchain programs or digital agreements that execute transactions between parties once a predetermined condition is met. For example, a smart contract wallet may be managed by a smart contract (e.g., or smart contract code) instead of a private key. As such, a smart contract wallet may improve speed, accuracy, trust, and/or transparency in blockchain operations. In some embodiments, a cryptography-based storage application may include, or have access to, a key-based wallet or a smart contract wallet. For example, the cryptography-based storage application may comprise a digital or other construct (e.g., a reference, a pointer, a text on a blockchain, an address, etc.).

As shown in FIG. 2, one or more user devices may include a private key (e.g., key 212) and/or digital signature. For example, system 200 may use cryptographic systems for conducting blockchain operations such as facilitating initial deployments of cryptographic assets across computer networks in a cryptographically secure manner while mitigating interactions with computer programs that simulate human activity. For example, system 200 may use public-key cryptography, which features a pair of digital keys (e.g., which may comprise strings of data). In such cases, each pair comprises a public key (e.g., which may be public) and a private key (e.g., which may be kept private). System 200 may generate the key pairs using cryptographic algorithms (e.g., featuring one-way functions). System 200 may then encrypt a message (or other blockchain operation) using an intended receiver's public key such that the encrypted message may be decrypted only with the receiver's corresponding private key. In some embodiments, system 200 may combine a message with a private key to create a digital signature on the message. For example, the digital signature may be used to verify the authenticity of blockchain operations. As an illustration, when conducting blockchain operations, system 200 may use the digital signature to prove to every node in the system that it is authorized to conduct the blockchain operations.

For example, system 200 may comprise a plurality of nodes for the blockchain network. Each node may correspond to a user device (e.g., user device 208). A node for a blockchain network may comprise an application or other software that records and/or monitors peer connections to other nodes and/or miners for the blockchain network. For example, a miner comprises a node in a blockchain network that facilitates blockchain operations by verifying blockchain operations on the blockchain, adding new blocks to the existing chain, and/or ensuring that these additions are accurate. The nodes may continually record the state of the blockchain and respond to remote procedure requests for information about the blockchain.

For example, user device 208 may request a blockchain operation (e.g., conduct a transaction). The blockchain operation may be authenticated by user device 208 and/or another node (e.g., a user device in the community network of system 200). For example, using cryptographic keys, system 200 may identify users and give access to their respective user accounts (e.g., corresponding digital wallets) within system 200. Using private keys (e.g., known only to the respective users) and public keys (e.g., known to the community network), system 200 may create digital signatures to authenticate the users.

Following an authentication of the blockchain operation (e.g., using key 212), the blockchain operation may be authorized. For example, after the blockchain operation is authenticated between the users, system 200 may authorize the blockchain operation prior to adding it to the blockchain. System 200 may add the blockchain operation to blockchain 206. System 200 may perform this based on a consensus of the user devices within system 200. For example, system 200 may rely on a majority (or other metric) of the nodes in the community network (e.g., user device 202, user device 208, and/or user device 210) to determine that the blockchain operation is valid. In response to validation of the block, a node user device (e.g., user device 202, user device 208, and/or user device 210) in the community network (e.g., a miner) may receive a reward (e.g., in a given cryptocurrency) as an incentive for validating the block.

To validate the blockchain operation, system 200 may use one or more validation protocols and/or validation mechanisms. For example, system 200 may use a proof-of-work mechanism in which a user device must provide evidence that it performed computational work to validate a blockchain operation and thus this mechanism provides a manner for achieving consensus in a decentralized manner as well as preventing fraudulent validations. For example, the proof-of-work mechanism may involve iterations of a hashing algorithm. The user device that is successful aggregates and records blockchain operations from a mempool (e.g., a collection of all valid blockchain operations waiting to be confirmed by the blockchain network) into the next block. Alternatively or additionally, system 200 may use a proof-of-stake mechanism in which a user account (e.g., corresponding to a node on the blockchain network) is required to have, or “stake,” a predetermined amount of tokens in order for system 200 to recognize it as a validator in the blockchain network.

In response to validation of the block, the block is added to blockchain 206, and the blockchain operation is completed. For example, to add the blockchain operation to blockchain 206, the successful node (e.g., the successful miner) encapsulates the blockchain operation in a new block before transmitting the block throughout system 200.

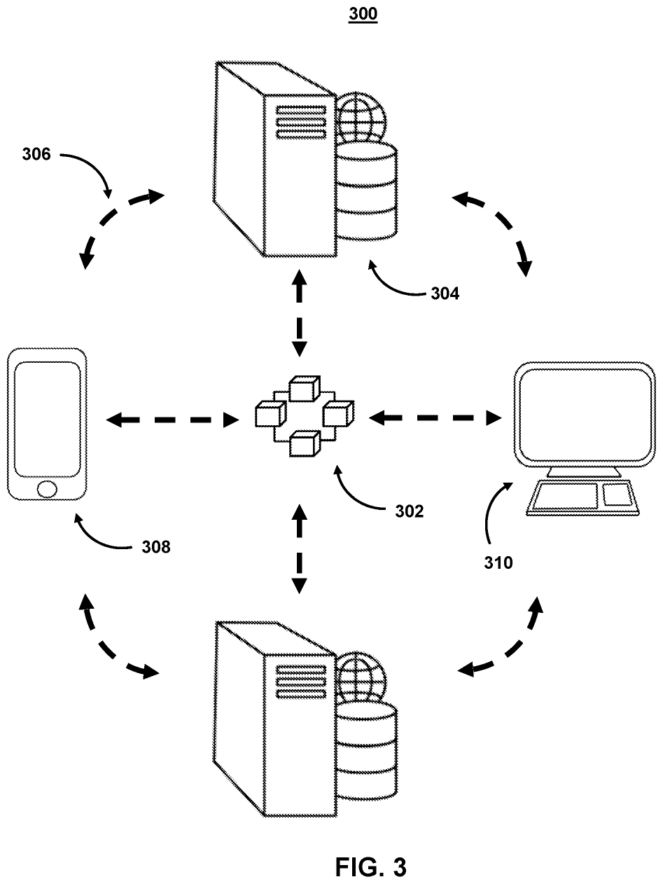

FIG. 3 shows an illustrative diagram for a decentralized application, in accordance with one or more embodiments. For example, in some embodiments, system 300 may facilitate initial deployments of cryptographic assets across computer networks in a cryptographically secure manner while mitigating interactions with computer programs that simulate human activity within a decentralized application environment. A decentralized application may comprise an application that exists on a blockchain (e.g., blockchain 302) and/or a peer-to-peer network (e.g., network 306). That is, a decentralized application may comprise an application that has a back end that is in part powered by a decentralized peer-to-peer network such as a decentralized, open-source blockchain with smart contract functionality.

For example, network 306 may allow user devices (e.g., user device 304) within network 306 to share files and access. In particular, the peer-to-peer architecture of network 306 allows blockchain operations (e.g., corresponding to blockchain 302) to be conducted between the user devices in the network, without the need of any intermediaries or central authorities.

In some embodiments, the user devices of system 300 may comprise one or more cloud components. For example, cloud components may be implemented as a cloud computing system and may feature one or more component devices. It should also be noted that system 300 is not limited to four devices. Users may, for instance, utilize one or more devices to interact with one another, one or more servers, or other components of system 300. It should be further noted that while one or more operations (e.g., blockchain operations) are described herein as being performed by a particular component (e.g., user device 304) of system 300, those operations may, in some embodiments, be performed by other components of system 300. As an example, while one or more operations are described herein as being performed by components of user device 304, those operations may, in some embodiments, be performed by one or more cloud components. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components (e.g., user device 304 and user device 308, respectively). Additionally, or alternatively, a single user (and/or a user account linked to a single user) may interact with system 300 and/or one or more components of system 300 using two different components (e.g., user device 304 and user device 308, respectively).

With respect to the components of system 300, each of these devices may receive content and data via input/output (hereinafter “I/O”) paths using I/O circuitry. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both user device 308 and user device 310 include a display upon which to display data (e.g., content related to one or more blockchain operations).

Additionally, the devices in system 300 may run an application (or another suitable program). The application may cause the processors and/or control circuitry to perform operations related to facilitating initial deployments of cryptographic assets across computer networks in a cryptographically secure manner while mitigating interactions with computer programs that simulate human activity within a decentralized application environment.

Each of these devices may also include electronic storages. The electronic storages may include non-transitory storage media that electronically stores information. The electronic storage media of the electronic storages may include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more optically readable storage media (e.g., optical disk, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes network 306, which may comprise communication paths between user devices. The communication paths may include the Internet, a mobile phone network, a mobile voice or data network (e.g., a 5G or LTE network), a cable network, a public switched telephone network, or other types of communication networks or combinations of communication networks. The communication paths may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

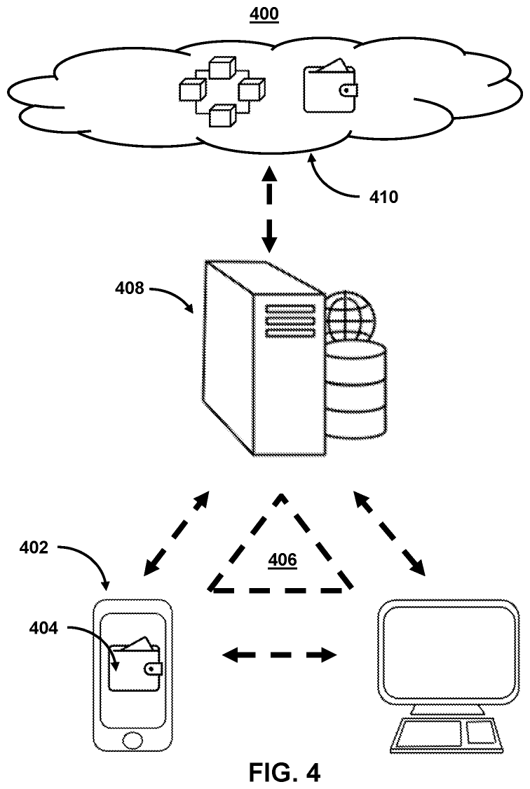

FIG. 4 shows an illustrative diagram for conducting operations in a decentralized application using blockchain operations, in accordance with one or more embodiments. For example, system 400 may include user device 402. Furthermore, user device 402 may comprise an application (e.g., application 404) that is implemented on, and/or accessible by, user device 402. For example, application 404 may interact with one or more other applications and/or application programming interfaces (APIs) in order to facilitate initial deployments of cryptographic assets across computer networks in a cryptographically secure manner while mitigating interactions with computer programs that simulate human activity. For example, application 404 may comprise a decentralized application digital wallet and/or wallet service that is able to sign and send transactions to transfer tokens and/or perform other blockchain operations as well as interact with one or more decentralized applications.

System 400 also includes API layer 406. In some embodiments, API layer 406 may be implemented on user device 402. Alternatively or additionally, API layer 406 may reside on one or more cloud components (e.g., server 408). For example, API layer 406 may reside on a server 408 and comprise a platform service for a custodial wallet service, decentralized application, etc. API layer 406 (which may be a representational state transfer (REST) or web services API layer) may provide a decoupled interface to data and/or functionality of one or more applications.

API layer 406 may provide various low-level and/or blockchain-specific operations in order to facilitate facilitating initial deployments of cryptographic assets across computer networks in a cryptographically secure manner while mitigating interactions with computer programs that simulate human activity. For example, API layer 406 may provide blockchain operations such as blockchain writes. Furthermore, API layer 406 may perform a transfer validation ahead of forwarding the blockchain operation (e.g., a transaction) to another service (e.g., a crypto service). API layer 406 may then log the outcome. For example, by logging to the blockchain prior to forwarding, the API layer 406 may maintain internal records and balances without relying on external verification (e.g., which may take up to ten minutes based on blockchain updating activity).

API layer 406 may also provide informational reads. For example, API layer 406 (or a platform service powered by API layer 406) may generate blockchain operation logs and write to an additional ledger (e.g., an internal record and/or indexer service) the outcome of the reads. If this is done, a user accessing the information through other means may see consistent information such that downstream users ingest the same data point as the user.

API layer 406 may also provide a unified API to access balances, transaction histories, and/or other blockchain operations activity records between one or more decentralized applications and custodial user accounts. By doing so, the system maintains the security of sensitive information such as the balances and transaction history. Alternatively, a mechanism for maintaining such security would separate the API access between the decentralized applications and custodial user accounts through the use of special logic. The introduction of the special logic decreases the streamlining of the system, which may result in system errors based on divergence and reconciliation.

API layer 406 may provide a common, language-agnostic way of interacting with an application. In some embodiments, API layer 406 may comprise a web services API that offers a well-defined contract that describes the services in terms of their operations and the data types used to exchange information. REST APIs do not typically have this contract; instead, they are documented with client libraries for most common languages including Ruby, Java, PHP, and JavaScript. Simple Object Access Protocol (“SOAP”) web services have traditionally been adopted in the enterprise for publishing internal services as well as for exchanging information with partners in business-to-business (“B2B”) transactions.

API layer 406 may use various architectural arrangements. For example, system 400 may be partially based on API layer 406, such that there is strong adoption of SOAP and RESTful web services, using resources such as Service Repository and Developer Portal, but with low governance, standardization, and separation of concerns. Alternatively, system 400 may be fully based on API layer 406, such that separation of concerns between layers such as API layer 406, services, and applications are in place.

In some embodiments, the system architecture may use a microservice approach. Such systems may use two types of layers: front-end layers and back-end layers, where microservices reside. In this kind of architecture, the role of the API layer 406 may be to provide integration between front-end and back-end layers. In such cases, API layer 406 may use RESTful APIs (exposition to front-end or even communication between microservices). API layer 406 may use the Advanced Message Queuing Protocol (AMQP), which is an open standard for passing business messages between applications or organizations. API layer 406 may use an open-source, high-performance remote procedure call (RPC) framework that may run in a decentralized application environment. In some embodiments, the system architecture may use an open API approach. In such cases, API layer 406 may use commercial or open-source API platforms and their modules. API layer 406 may use a developer portal. API layer 406 may use strong security constraints applying a web application firewall that protects the decentralized applications and/or API layer 406 against common web exploits, bots, and denial-of-service (DDOS) attacks. API layer 406 may use RESTful APIs as standard for external integration.

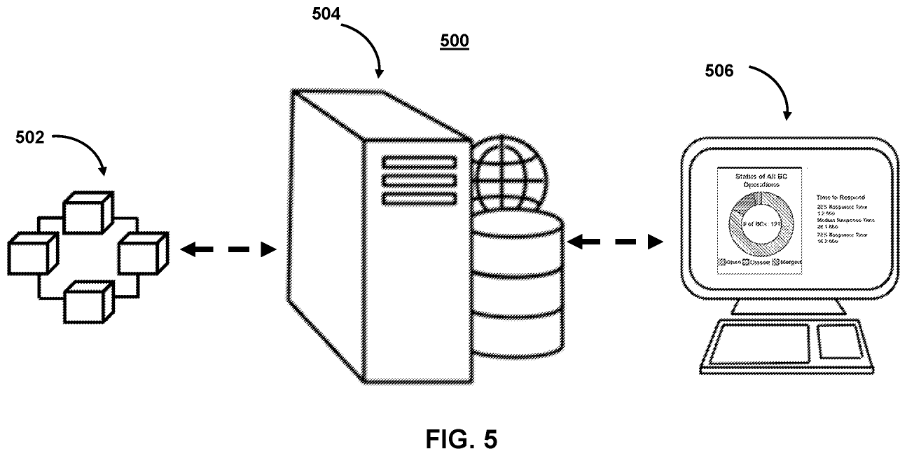

As shown in FIG. 4, system 400 may use API layer 406 to communicate with and/or facilitate blockchain operations with server 408. For example, server 408 may represent a custodial platform for blockchain operations. A custodial platform may manage private keys stored by a centralized service provider (e.g., server 408). In such cases, server 408 may interact with blockchain 410, a wallet service for blockchain 410, an indexer service for blockchain 410 (e.g., as described in FIG. 5), and/or other platform services.

For example, a wallet service may comprise an application and/or a software-based system that securely stores users' payment information, private keys, and/or passwords facilitating blockchain operations with websites, nodes, and/or other devices. In some embodiments, a wallet service may also provide additional ledger access (e.g., a second ledger). Furthermore, as discussed above, this second ledger may receive updates directly from API layer 406, as opposed to relying on data pulled directly from blockchain 410.

For example, system 400 may maintain its records (e.g., both live and for accounting) in good order separate from balances on blockchain 410. That is, system 400 may maintain an architecture featuring the second ledger, where balances are stored and updated, and the logs of blockchain operations. While conventional systems may rely on directly referencing blockchain 410, since the blockchain is the source of truth for the system, however, such reliance leads to additional technical problems.

First, there is a strong likelihood of impedance mismatch between a format for a platform service and the APIs used to retrieve data from the blockchain (e.g., which may lead to accounting imbalances). For example, system 400 may need to be able to generate accounting entries reflecting changes of balances. However, while changes of balances can be tracked by examining blockchain 410, this requires additional processing and computational power.

Second, accounting changes in a blockchain architecture should be irreversible. This is achieved in practice for current blockchain operations by waiting for a variable number of confirmations from the blockchain (e.g., blockchain 410). By waiting for the variable number of confirmations, the likelihood of an error in the blockchain becomes infinitesimally small. However, while blockchain services rely on this methodology, this is not a rule inherent to the blockchain itself. That is, the blockchain does not have an inherent authentication mechanism that is dependent on a number of confirmations. Instead, the blockchain relies on an absolute system-blockchain operations are either recorded on a particular node or they are not.

As such, forks in the blockchain are always possible. In the case of a fork, system 400 may not follow the “right” fork for an undetermined amount of time. If that happens, and if, for the purpose of a custodial digital wallet, system 400 decides to move from one fork to another, system 400 may have a more straightforward mechanism to maintain an accurate history of a user account's positions if system 400 stores them independently from a given blockchain. Furthermore, in case of forks, system 400 performs some internal remediation on user accounts, which is enabled by system 400 maintaining a layer of insultation, from the blockchain, for remedial blockchain operations. For example, system 400 may have a separate storage, protected by the second ledger (e.g., a ledger service), for reads, and by a transfer service, for writes, that reflect the state of the blockchain that is relevant for system 400 purposes.

In some embodiments, the system may also use one or more Application Binary Interfaces (ABIs). An ABI is an interface between two program modules, often between operating systems and user programs. ABIs may be specific to a blockchain protocol. For example, an Ethereum Virtual Machine (EVM) is a core component of the Ethereum network, and a smart contract may be a piece of code stored on the Ethereum blockchain, which are executed on EVM. Smart contracts written in high-level languages like Solidity or Vyper may be compiled in EVM executable bytecode by the system. Upon deployment of the smart contract, the bytecode is stored on the blockchain and is associated with an address. To access functions defined in high-level languages, the system translates names and arguments into byte representations for byte code to work with it. To interpret the bytes sent in response, the system converts back to the tuple (e.g., a finite ordered list of elements) of return values defined in higher-level languages. Languages that compile for the EVM maintain strict conventions about these conversions, but in order to perform them, the system must maintain the precise names and types associated with the operations. The ABI documents these names and types precisely, and in a easily parseable format, making translations between human-intended method calls and smart contract operations discoverable and reliable.

For example, ABI defines the methods and structures used to interact with the binary contract similar to an API, but on a lower-level. The ABI indicates the caller of the function to encode (e.g., ABI encoding) the needed information like function signatures and variable declarations in a format that the EVM can understand to call that function in bytecode. ABI encoding may be automated by the system using compilers or wallets interacting with the blockchain.

FIG. 5 shows an illustrative diagram for a blockchain indexer, in accordance with one or more embodiments. For example, in some embodiments, the system may use indexer service 500 to facilitate initial deployments of cryptographic assets across computer networks in a cryptographically secure manner while mitigating interactions with computer programs that simulate human activity. Indexer service 500 may fetch raw data (e.g., data related to a current state and/or instance of blockchain 502) from a node of a blockchain network (e.g., as described above). Indexer service 500 may then process the data and store it in a database and/or data structure in an efficient way to provide quick access to the data. For example, indexer 504 may publish and/or record a subset of blockchain operations that occur for blockchain 502. Accordingly, for subsequent blockchain operations, indexer service 500 may reference the index at indexer 504 as opposed to a node of blockchain 502 to provide various services at user device 506.

For example, indexer 504 may store a predetermined list of blockchain operations to monitor for and/or record in an index. These may include blockchain operations (e.g., “operation included,” “operation removed,” “operation finalized”) related to a given type of blockchain operation (e.g., “transaction,” “external transfer,” “internal transfer,” “new contract metadata,” “ownership change,” etc.) as well as blockchain operations related to a given protocol, protocol subgroup, and/or other characteristic (e.g., “ETH,” “ERC20,” and/or “ERC721”). Additionally and/or alternatively, the various blockchain operations and metadata related to those blockchain operations (e.g., block designations, user accounts, time stamps, etc.) as well as an aggregate of multiple blockchain operations (e.g., total blockchain operations amounts, rates of blockchain operations, rate of blockchain updates, etc.) may be monitored and/or recorded.

Indexer 504 may likewise provide navigation and search features (e.g., support Boolean operations) for the indexed blockchain operations. In some embodiments, indexer 504 may apply one or more formatting protocols to generate representations of indexed blockchain operations in a human-readable format. In some embodiments, indexer 504 may also tag blockchain operations based on whether or not the blockchain operation originated for a local user account (e.g., a user account corresponding to a custodial account) and/or a locally hosted digital wallet. Indexer service 500 may determine whether a blockchain operation contains relevant information for users of indexer service 500 by storing information about whether an address is an internal address of indexer service 500 or one used in a digital wallet hosted by a predetermined wallet service.

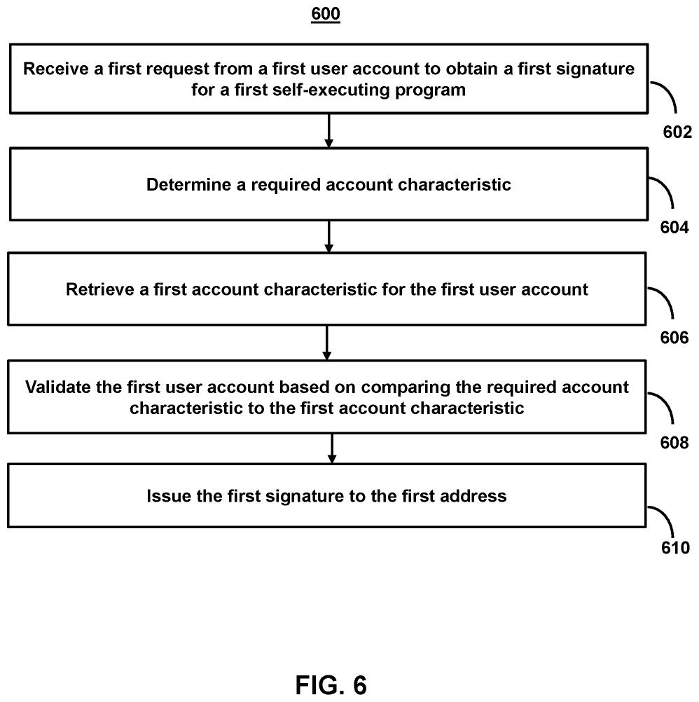

FIG. 6 shows a flowchart of the steps involved in facilitating initial deployments of cryptographic assets across a computer network in a cryptographically secure manner while mitigating interactions with computer programs that simulate human activity, in accordance with one or more embodiments. For example, the system may use process 600 (e.g., as implemented on one or more system components described above) in order to pre-validate potential purchases which limits bot-operations and to minimize gas fees for users for failed transactions.

At step 602, process 600 (e.g., using one or more components described above) receives a first request from a first user account to obtain a first signature for a first self-executing program. For example, the system may receive a first request, e.g., from a first user account corresponding to a first address of a cryptography-based storage application, to obtain a first signature for a first self-executing program. In some examples, the first self-executing program may be configured to authorize transfer of a first previously-minted unique digital asset of a first unique digital asset collection. For example, the self-executing program authorizes a sale of a previously-minted unique digital asset. By doing so, the system allows for a drop to maintain the prestige of being an initial release or delivery date of the non-fungible tokens but does not require the smart contract executing the sale to mint the non-fungible token. As such, the system may pre-validate a potential customer before transferring the non-fungible token to the customer.

At step 604, process 600 (e.g., using one or more components described above) determines a required account characteristic. For example, the system may determine a required account characteristic based on the first request. For example, a creator for the non-fungible token collection may add requirements to any user account for obtaining a previously-minted non-fungible token. By doing so, the system may ensure that the non-fungible token is being bought by a user who meets one or more (or all) of the requirements of the creator. Therefore, the system may ensure that the customer is not a bot, and the creator will not have to refund gas fees for failed transactions.

At step 606, process 600 (e.g., using one or more components described above) retrieves a first account characteristic for the first user account. For example, the system may retrieve a first account characteristic for the first user account. For example, the system may retrieve information about a user and/or user account including previous blockchain operations, potential future blockchain operations, user and/or account settings, user and/or account preferences, and/or other information about the user, user device, and/or user account. By doing so, the system may ensure that the user's account belongs to a real user and not a bot. Therefore, the system stops bot-operations and prevents gas wars.

At step 608, process 600 (e.g., using one or more components described above) validates the first user account based on comparing the required account characteristic to the first account characteristic. For example, the system may validate the first user account based on comparing the required account characteristic to the first account characteristic. For example, the system may validate the first user account by determining whether a digital wallet corresponding to the first user account has a balance equal to or more than an offer price of the non-fungible token. By doing so, the system may ensure that the customer does not pay high gas fees for a failed blockchain operation during a drop. For example, by ensuring the digital wallet has a balance equal to or more than an offer price of the non-fungible token, the system is able to limit the amount of failed transactions.

In some embodiments, the required account characteristic may include a social media characteristic of the first user account. For example, the required account characteristic may include a social media characteristic of the first user account. The system may in retrieving the first account characteristic for the first user account, retrieve the social media characteristic for the first user account. For example, the system may require that a user account is linked to an existing social media account in order to ensure that the first user account is not a bot account. For example, the system may require an account characteristic such as a number of connections in a social media account, a length of time that the social media account has been active or contact information for the social media account. By doing so, the system may ensure that the non-fungible token is not a bot-purchase. For example, by requiring the customer to have a linking social media account, the system is verifying the customer is a real life user and not a bot. In some examples, validating the first user account includes verifying that a social media account linked to the user account follows a particular social media account.

In some embodiments, the required account characteristic may include a know-your-customer characteristic of the first user account. For example, the system may in retrieving the first account characteristic for the first user account, retrieve the know-your-customer characteristic for the first user account. For example, the system may require that a user account is linked to an existing entity (e.g., based on know-your-customer data) in order to ensure that the first user account is not a bot account. For example, the system may require an account characteristic such as a number of previous purchases, a length of time that the user account has been active, an amount of digital assets in an account, etc. By doing so, the system is able to verify that the customer is a real user and not a bot. Therefore, the system limits bot purchases and prevents gas wars. In some examples, validating the first user account includes verifying that the first user account has completed a know-your-customer process (e.g., including verifying the know-your-customer characteristic).

In some embodiments, the required account characteristic may include a blockchain address of the first user account. For example, the system may, in retrieving the first account characteristic for the first user account, retrieve the blockchain address for the first user account. For example, the system may require that a user account is linked to a known digital wallet. For example, the system may require an account characteristic indicating that the first user account is linked to a previously used digital wallet and/or a custodial wallet for a platform service. By doing so, the system may ensure that the first user account is not a bot account. Therefore, the system limits bot purchases and prevents gas wars.

In some embodiments, the required account characteristic may include ownership of an additional unique digital asset by the first address. For example, the system may in retrieving the first account characteristic for the first user account, determine whether the first address currently owns the additional unique digital asset based on a current state of a blockchain. For example, the system may require that a user previously obtained another unique digital asset and/or other digital asset. In such cases, the system may retrieve a current state of a blockchain to determine whether the current state indicates that the other unique digital asset is owned by the address associated with the first user account. By doing so, the system may ensure that the first user account is not a bot account. Therefore, the system limits bot purchases and prevents gas wars.

At step 610, process 600 (e.g., using one or more components described above) issues the first signature to the first address of the cryptography-based storage application. For example, the system may issue the first signature to the first address of the cryptography-based storage application. For example, after validating the signature the system may transfer the unique digital asset from the creator of the unique digital asset to the user's cryptography-based storage application, e.g., by issuing the signature to an address of the storage application. By doing so, the system may pre-validate potential purchases, which limits bot-operations and minimizes gas fees associated with failed transactions.

In some embodiments, the first self-executing program may be configured to perform operations including receiving the first signature from the first address of the cryptography-based, storage application, validating the first signature, and transferring the first previously-minted unique digital asset to the first address of the cryptography-based, storage application.

In some examples, validating the first signature may include verifying that the first signature was issued by a second address associated with the platform service. Alternatively or additionally, validating the first signature may include verifying that the first signature was received from the first address of the cryptography-based, storage application.

In some embodiments, the first self-executing program is configured to verify that the first signature was received by a predefined time. For example, the first self-executing program may ensure that the first signature is being conducted within a time window specified by the signature by encoding the signature with a specified time window at which the signature may be used to obtain the unique digital asset. By doing so, the system may limit a bot's ability to obtain the non-fungible token.

In some embodiments, transferring the first previously-minted unique digital asset includes transferring another previously-minted unique digital asset of the first unique digital asset collection to the first address of the cryptography-based, storage application. For example, the system may transfer more than one previously-minted digital asset to the first address of the cryptography-based, storage application. By doing so, the customer is able to receive a collection of non-fungible tokens at one time.

In some embodiments, transferring the first previously-minted unique digital assets occurs in response to a set of one or more criteria being met. For example, the system may transfer the first previously-minted unique digital assets in response to a set of one or more criteria being met, the set of one or more criteria being including verifying that the first signature was issued by a second address associated with the platform service, verifying that the first signature was received from the first address of the cryptography-based, storage application, and verifying that the first signature was received by a predefined time. For example, the system may only transfer the first previously-minted unique digital asset to the customer after verifying that it was not a bot purchase. By doing so, the system is able to limit a bot's ability to obtain the non-fungible token.

In some embodiments, the first signature may include a first blockchain operation characteristic for the first blockchain operation. For example, the first signature comprises a first blockchain operation characteristic for the first blockchain operation, wherein the first signature is based on the first blockchain operation. For example, the first self-executing program may include conditions related to a blockchain operation to obtain the first previously-minted unique digital asset such as a price corresponding to the blockchain operation, a particular unique digital asset corresponding to the blockchain operation, and/or a time window corresponding to the blockchain operation. By doing so, the system may ensure the user is able to buy multiple non-fungible tokens in a collection without making multiple separate buys.

In some embodiments, the first blockchain operation characteristic may comprise a value for obtaining the first previously-minted unique digital asset. For example, the first blockchain operation characteristic comprises a value for obtaining the first previously-minted unique digital asset, wherein the first signature comprises authorization to obtain the first previously-minted unique digital asset for the value. For example, the system may request a user request to purchase a non-fungible token at a given value (e.g., price). In response, the system may generate a signature that authorizes the user account to purchase the non-fungible token at that value. By doing so, the system may ensure the user is able to purchase the unique digital asset without it being a failed transaction.

In some embodiments, in retrieving the first account characteristic for the first user account, the system may retrieve a current amount in the first address of the cryptography-based storage application. For example, the system in retrieving the first account characteristic for the first user account may retrieve a current amount in a cryptography-based storage application for the first user account, and wherein validating the first user account based on the first account characteristic comprises determining whether the current amount equals or exceeds a required value for the first previously-minted unique digital asset. For example, the system may validate the first user account by determining whether a digital wallet corresponding to the first user account has a balance equal to or more than an offer price of the non-fungible token. By doing so, the system may ensure the user is able to purchase the unique digital asset without it being a failed transaction.

In some embodiments, the first blockchain operation characteristic may comprise a time window for obtaining the first previously-minted unique digital asset. For example, the first blockchain operation characteristic may comprise a time window for obtaining the first previously-minted unique digital asset, wherein the first signature comprises authorization to obtain the first previously-minted unique digital asset during the time window. For example, the system may request a user request to purchase a non-fungible token at a given value (e.g., price). In response the system may generate a signature that authorizes the user account to purchase the non-fungible token at that value for a limited time period. By doing so, the system may limit a bot's ability to obtain the non-fungible token.

In some embodiments, in issuing the first signature, the system may encode a time into the first signature, e.g., a time at which the first signature was created. For example, the system may, in issuing the first signature to the first user account, encode the time window into the first signature. For example, the system may ensure that blockchain operation is being conducted within a time window specified by the self-executing contract by encoding the self-executing contract with a specified time window at which the signature may be used to obtain the unique digital asset. By doing so, the system may limit a bot's ability to obtain the non-fungible token.

In some embodiments, the first blockchain operation characteristic may include a unique digital asset identifier for the first previously-minted unique digital asset. For example, the first blockchain operation characteristic may include a unique digital asset identifier for the first previously-minted unique digital asset, wherein the first signature may include authorization to obtain a unique digital asset from the first unique digital asset collection corresponding to the unique digital asset identifier. By doing so, the system may ensure the correct non-fungible token is being issued to the customer.

In some embodiments, the system may retrieve a list of identifiers corresponding to available unique digital assets. For example, the system may retrieve a list of identifiers corresponding to available unique digital assets in the first unique digital asset collection. The system may compare the unique digital asset identifier to the list of identifiers. The system may determine whether a unique digital asset identified by a request is still available (e.g., a signature authorizing a user account to obtain the unique digital asset has not previously been issued). In response to determining that the unique digital asset is available, the system may proceed with issuing the signature. In response to determining that the unique digital asset is not available, the system may generate a message indicating that the digital asset is not available and/or add the user account to a queue (e.g., a wait list). In such cases, the system may encode the current queue and/or requirements therefor into the signature issued to the user account. By doing so, the system may notify the user of their status in obtaining the non-fungible token.

In some embodiments, in order to allow the self-executing program to transfer first unique digital asset collection from the address of the owner to another address, the setApprovalForAll( ) function may need to be executed. The setApprovalForAll( ) function is triggered when the address with the first unique digital asset collection executes the function and gives approval rights to a designated address, such as the address of the self-executing program.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for facilitating initial deployments of cryptographic assets across a computer network in a cryptographically secure manner while mitigating interactions with computer programs that simulate human activity.
2. The method of the preceding embodiment comprising: receiving a first request, from a first user account corresponding to a first address of a cryptography-based storage application, to obtain a first signature for a first self-executing program, wherein the first self-executing program is configured to authorize a transfer of a first previously-minted unique digital asset of a first unique digital asset collection; in response to the first request, determining a required account characteristic based on the first request; retrieving a first account characteristic for the first user account; validating the first user account based on comparing the required account characteristic to the first account characteristic; and issuing the first signature to the first address of the cryptography-based storage application.
3. The method of any one of the preceding embodiments, wherein the first signature comprises a first blockchain operation characteristic for the first blockchain operation, and wherein the first signature is based on the first blockchain operation.
4. The method of any one of the preceding embodiments, wherein the first blockchain operation characteristic comprises a value for obtaining the first previously-minted unique digital asset, and wherein the first signature comprises authorization to obtain the first previously-minted unique digital asset for the value.
5. The method of any one of the preceding embodiments, wherein retrieving the first account characteristic for the first user account comprises retrieving a current amount in the first address of the cryptography-based storage application for the first user account, and wherein validating the first user account based on the first account characteristic comprises determining whether the current amount equals or exceeds a required value for the first previously-minted unique digital asset.
6 The method of any one of the preceding embodiments, wherein the first blockchain operation characteristic comprises a time window for obtaining the first previously-minted unique digital asset, and wherein the first signature comprises authorization to obtain the first previously-minted unique digital asset during the time window.
7. The method of any one of the preceding embodiments, wherein issuing the first signature to the first user account comprises encoding the time window into the first signature.
8. The method of any one of the preceding embodiments, wherein the first blockchain operation characteristic comprises a unique digital asset identifier for the first previously-minted unique digital asset, and wherein the first signature comprises authorization to obtain a unique digital asset from the first unique digital asset collection corresponding to the unique digital asset identifier.
9. The method of claim 8, further comprising: retrieving a list of identifiers corresponding to available unique digital assets in the first unique digital asset collection; and comparing the unique digital asset identifier to the list of identifiers.
10. The method of claim 2, wherein the required account characteristic comprises a social media characteristic of the first user account, wherein retrieving the first account characteristic for the first user account comprises retrieving the social media characteristic for the first user account, and wherein validating the first user account includes verifying that a social media account linked to the user account follows a particular social media account.
11. The method of claim 2, wherein the required account characteristic comprises a know-your-customer characteristic of the first user account, wherein retrieving the first account characteristic for the first user account comprises retrieving the know-your-customer characteristic for the first user account, and wherein validating the first user account includes verifying that the first user account has completed a know-your-customer process.
12. The method of claim 2, wherein the required account characteristic comprises a blockchain address of the first user account, and wherein retrieving the first account characteristic for the first user account comprises retrieving the blockchain address for the first user account.
13. The method of claim 2, wherein the required account characteristic comprises ownership of an additional unique digital asset by the first address, and wherein retrieving the first account characteristic for the first user account comprises determining whether the first address owns the additional unique digital asset based on a current state of a blockchain.
14. The method of claim 2, further comprising: determining whether a setApprovalForAll( ) self-executing program has been issued; and in response to determining that the setApprovalForAll( ) self-executing program has been issued, generating for display, on a user interface, a listing for the first unique digital asset collection.
15. A tangible, non-transitory, machine-readable medium storing instructions that, when executed by a data processing apparatus, cause the data processing apparatus to perform operations comprising those of any of embodiments 1-15.
16. A system comprising one or more processors; and memory storing instructions that, when executed by the processors, cause the processors to effectuate operations comprising those of any of embodiments 1-15.
17. A system comprising means for performing any of embodiments 1-15.

What is claimed is:

1. A system for facilitating initial deployments of cryptographic assets across a computer network in a cryptographically secure manner while mitigating interactions with computer programs that simulate human activity, the system comprising:
a cryptography-based platform service configured to perform operations comprising:
generating for display, on a user interface, a listing for a first unique digital asset collection;
receiving a user selection selecting a visual element corresponding to a first previously-minted unique digital asset of the first unique digital asset collection;
based on the user selection, generating a first request, from a first user account corresponding to a first address of a cryptography-based storage application, to obtain a first signature for a first self-executing program;
based on the first request, determining a required account characteristic based on the first request;
retrieving a first account characteristic for the first user account;
validating the first user account based on comparing the required account characteristic to the first account characteristic; and
issuing the first signature to the first address of the cryptography-based storage application; and
the first self-executing program configured to perform operations comprising:
receiving the first signature from the first address of the cryptography-based storage application;
validating the first signature; and
transferring the first previously-minted unique digital asset to the first address of the cryptography-based storage application.

2. The system of claim 1, wherein validating the first signature comprises verifying that the first signature was issued by a second address associated with the platform service.

3. The system of claim 1, wherein validating the first signature comprises verifying that the first signature was received from the first address of the cryptography-based storage application.

4. The system of claim 1, wherein the first self-executing program is configured to perform operations further comprising:
verifying that the first signature was received by a predefined time.

5. The system of claim 1, wherein transferring the first previously-minted unique digital asset includes transferring another previously-minted unique digital asset of the first unique digital asset collection to the first address of the cryptography-based storage application.

6. The system of claim 1, wherein transferring the first previously-minted unique digital asset occurs in response to a set of one or more criteria being met, the set of one or more criteria being including:
verifying that the first signature was issued by a second address associated with the platform service;
verifying that the first signature was received from the first address of the cryptography-based storage application; and
verifying that the first signature was received by a predefined time.

7. The system of claim 1, wherein the required account characteristic comprises a social media characteristic of the first user account, wherein retrieving the first account characteristic for the first user account comprises retrieving the social media characteristic for the first user account, and wherein validating the first user account includes verifying that a social media account linked to the first user account follows a particular social media account.

8. The system of claim 1, wherein the required account characteristic comprises a know-your-customer characteristic of the first user account, wherein retrieving the first account characteristic for the first user account comprises retrieving the know-your-customer characteristic for the first user account, and wherein validating the first user account includes verifying that the first user account has completed a know-your-customer process.

9. The system of claim 1, wherein the required account characteristic comprises ownership of an additional unique digital asset by the first address, wherein retrieving the first account characteristic for the first user account comprises determining whether the first address of the cryptography-based storage application currently owns the additional unique digital asset based on a current state of a blockchain.

10. A method for facilitating initial deployments of cryptographic assets across a computer network in a cryptographically secure manner while mitigating interactions with computer programs that simulate human activity, the method comprising:
receiving a first request, from a first user account corresponding to a first address of a cryptography-based storage application, to obtain a first signature for a first self-executing program, wherein the first self-executing program is configured to authorize a transfer of a first previously-minted unique digital asset of a first unique digital asset collection;
determining a required account characteristic based on the first request;
retrieving a first account characteristic for the first user account;
validating the first user account based on comparing the required account characteristic to the first account characteristic; and
issuing the first signature to the first address of the cryptography-based storage application.

11. The method of claim 10, wherein retrieving the first account characteristic for the first user account comprises retrieving a current amount in the first address of the cryptography-based storage application for the first user account, and wherein validating the first user account based on the first account characteristic comprises determining whether the current amount equals or exceeds a required value for the first previously-minted unique digital asset.

12. The method of claim 10, wherein the required account characteristic comprises a social media characteristic of the first user account, wherein retrieving the first account characteristic for the first user account comprises retrieving the social media characteristic for the first user account, and wherein validating the first user account includes verifying that a social media account linked to the first user account follows a particular social media account.

13. The method of claim 10, wherein the required account characteristic comprises a know-your-customer characteristic of the first user account, wherein retrieving the first account characteristic for the first user account comprises retrieving the know-your-customer characteristic for the first user account, and wherein validating the first user account includes verifying that the first user account has completed a know-your-customer process.

14. The method of claim 10, wherein the required account characteristic comprises ownership of an additional unique digital asset by the first address, and wherein retrieving the first account characteristic for the first user account comprises determining whether the first address currently owns the additional unique digital asset based on a current state of a blockchain.

15. A non-transitory computer readable medium having instructions recorded thereon that when executed by one or more processors cause operations comprising:
receiving from a platform service a first signature, wherein the first signature is generated by the platform service based on:
receiving a first request, from a first user account corresponding to a first address of a cryptography-based storage application, to obtain the first signature for a first self-executing program, wherein the first self-executing program is configured to authorize a transfer of a first previously-minted unique digital asset of a first unique digital asset collection;
determining a required account characteristic based on the first request;
retrieving a first account characteristic for the first user account;
validating the first user account based on comparing the required account characteristic to the first account characteristic;
issuing the first signature to the first address of the cryptography-based storage application; and
executing the first self-executing program using the first signature.

16. The non-transitory computer readable medium of claim 15, wherein retrieving the first account characteristic for the first user account comprises retrieving a current amount in the first address of the cryptography-based storage application for the first user account, and wherein validating the first user account based on the first account characteristic comprises determining whether the current amount equals or exceeds a required value for the first previously-minted unique digital asset.

17. The non-transitory computer readable medium of claim 15, wherein the required account characteristic comprises a social media characteristic of the first user account, wherein retrieving the first account characteristic for the first user account comprises retrieving the social media characteristic for the first user account, and wherein validating the first user account includes verifying that a social media account linked to the first user account follows a particular social media account.

18. The non-transitory computer readable medium of claim 15, wherein the required account characteristic comprises a know-your-customer characteristic of the first user account, wherein retrieving the first account characteristic for the first user account comprises retrieving the know-your-customer characteristic for the first user account, and wherein validating the first user account includes verifying that the first user account has completed a know-your-customer process.

19. The non-transitory computer readable medium of claim 15, wherein the required account characteristic comprises ownership of an additional unique digital asset by the first address, and wherein retrieving the first account characteristic for the first user account comprises determining whether the first address currently owns the additional unique digital asset based on a current state of a blockchain.

20. The non-transitory computer readable medium of claim 15, wherein the first signature comprises a first blockchain operation characteristic for the first blockchain operation, wherein the first blockchain operation characteristic comprises a value for obtaining the first previously-minted unique digital asset, and wherein the first signature comprises authorization to obtain the first previously-minted unique digital asset for the value.
